(19) United States
(12) Patent Application Publication
(10) Pub. No.: US 2026/0142456 A1
(43) Pub. Date: May 21, 2026

(54) METHODS AND DEVICES FOR MINIMIZING A POSSIBLY CORRODING DC PROTECTIVE-CONDUCTOR CURRENT

(71) Applicant: Bender GmbH & Co. KG, Gruenberg (DE)

(72) Inventor: Dieter Hackl, Fernwald (DE)

(21) Appl. No.: 19/390,961

(22) Filed: Nov. 17, 2025

(30) Foreign Application Priority Data
Nov. 18, 2024 (DE) 10 2024 133 671.4

(51) Int. Cl. H02J 1/14

(52) U.S. Cl. CPC H02J 1/14

(57) ABSTRACT

Methods and devices for minimizing a possibly corroding DC protective-conductor current for a DC system grounded via a protective conductor designed as a foundation ground electrode with connected SK 1-operating equipment. Balancing includes feeding a balancing current to a casing of the class I operating equipment at a ground terminal via an output circuit between a fault-free active conductor and ground terminal, a balancing-current polarity and amplitude set such that the DC protective-conductor current is minimized in the foundation ground electrode. In contrast to DC balancing, DC compensation means a compensating current is fed to the casing at the ground terminal of the class I operating equipment via an output current between the faulty active conductor and the ground terminal. Regarding the polarity and the amplitude, the compensating current is such that the DC protective-conductor current is minimized in the foundation ground terminal. The balancing current and the compensating current are set via switching of power sources, resistors or a PWM signal.

This application claims the benefit of German patent application no. 102024133 671.4, filed November 18, 2024, the disclosure of which is incorporated herein by reference.

### TECHNICAL FIELD

The invention relates to methods and devices for minimizing a possibly corroding DC protective-conductor current for a DC system, which is grounded via a protective conductor designed as a foundation ground electrode and has connected class I operating equipment.

### BACKGROUND

In industrial power supply systems operated using a grounded network configuration as well as in grounded heavy-current machines, significantly higher protective-conductor currents are tolerated during normal operation than, for example, in domestic applications.

In alternating current (AC) and three-phase current (3AC) networks, these high protective-conductor currents usually result from a combination of large network leakage capacities present in the system and the use of converter operating equipment.

With the increasing use of operating equipment powered by direct current (DC) systems with a grounded network configuration and the increasing use of grounded AC systems with galvanically connected DC circuits, excessive DC protective-conductor currents pose an increased risk of electrocorrosion in grounding systems (protective grounding systems) in buildings, even with enhanced protective measures regarding the fixed connection of operating equipment and robust protective-conductor design.

This applies in particular to foundation ground electrodes, which are embedded in the concrete of a building foundation as a closed ring along the outer edges. The foundation ground electrode is connected in an electrically conductive manner to the reinforcement of the foundation or floor slab by means of screw, clamp, or welded connections. On the DC side, in the application case considered here, operating equipment having a protectively grounded casing (class I operating equipment) is connected by means of a protective conductor. The application case in which several pieces of class I operating equipment are disposed in an electrical enclosure grounded by means of the protective conductor (grounding cable) via the electrical-enclosure casing is also considered.

If passivable metals come into contact with electrolytic materials such as the concrete of the building foundation, corrosion processes only proceed until an equilibrium state is reached without the influence of external DC voltage sources. The use of rust-brown reinforcement steel mesh in the construction of concrete foundations is well known here.

Once the passivation of the reinforcement steel mesh is mostly complete, ideally hardly any corrosion processes will take place after the reinforcement steel mesh has been inserted into the foundation concrete.

In order to leave the passivation state in the metal-electrolyte combination under the influence of an external DC source and to restart corrosion processes, a certain activation potential must be exceeded.

The EN 50162 standard specifies a typical activation potential of 200 mV for the combination between structural steel and concrete. The activation potentials vary depending on the combination between metal and electrolyte, but are usually in the range below 1 V.

If the specific activation potential is exceeded by an excessively high DC protective-conductor current in the foundation ground electrode, it is likely that corrosion processes will start on metallic components (reinforcement steel mesh) which are grounded via the foundation ground electrode and are in contact with electrolytic material (concrete), which may affect the service life of the structure.

Various measures for reducing corrosion caused by DC stray currents are known from the prior art. The EN 50162 standard recommends, among other things, operation with an ungrounded network configuration, the use of protective coatings for metal parts, or the use of corrosion protection devices.

In addition, measures such as the use of a protective conductor having a significantly larger cross section or the use of additional protective equipotential bonding having an insulated protective conductor are taken.

However, all of the above measures are associated with high material and installation costs.

The present invention is therefore based on the task of describing a method and a device for class I operating equipment or for several pieces of class I operating equipment disposed in a grounded electrical enclosure, which are connected in a grounded DC system via a protective conductor designed as a foundation ground electrode, the method and the device both minimizing the DC protective-conductor current in the foundation ground electrode in an economically acceptable manner so that the specific activation potentials required for the start of corrosion processes in the grounding system are not exceeded.

### SUMMARY

The basic idea behind the invention for solving the problem is to use circuitry measures to bring about a still acceptable DC component at the ground terminal (of a casing) of the class I operating equipment or the grounded electrical enclosure for the protectively grounded operating equipment (class I operating equipment) and/or for several pieces of class I operating equipment disposed in a grounded electric enclosure, thereby minimizing the DC protective-conductor current in order to prevent the activation of corrosion processes in grounding systems for buildings.

For this purpose, methods and devices for DC balancing using a balancing current and methods and devices for DC compensation using a compensating current are proposed. The DC system, including the protective conductor, and the connected class I operating equipment represent the application environment of the invention and are not part of the invention.

In relation to a balancing method, the underlying task is solved by feeding a balancing current to a casing of the class I operating equipment at a ground terminal via an output circuit between a fault-free active conductor and the ground terminal, a balancing-current polarity and a balancing-current amplitude of the balancing current being set in such a manner that the DC protective-conductor current is minimized in the foundation ground electrode.

In the (DC) balancing method, the balancing current is fed into the protective-grounding system via an output circuit, which extends between the fault-free active conductor and the ground terminal on the casing of the class I operating equipment, at the ground terminal of the class I operating equipment casing—in the DC system having two active conductors considered here, in the event of a single-pole (unbalanced) insulation fault, the fault-free active conductor corresponds to the active conductor of opposite polarity.

The balancing current is set in terms of polarity (balancing-current polarity) and amplitude (balancing-current amplitude) so that the DC protective-conductor current in the foundation ground electrode is minimized, i.e., the specific activation potential is not exceeded.

In a further embodiment, the balancing-current polarity and the balancing-current amplitude is set by registering the amplitude and the polarity of a DC fault current , which is derived from the DC system in the protective conductor, upstream of the ground terminal by means of a current sensor; generating a measuring voltage proportional to the registered DC fault current by means of the current sensor; filtering the measuring voltage by means of a filtering device; and generating the balancing current proportional to the measuring voltage by means of a voltage-controlled power source.

The DC fault current, which is diverted to the protective conductor via the faulty conductor and detected by a current sensor, generates a measuring voltage proportional to the detected DC fault current in the current sensor. This is based on a DC fault current occurring at one of the active conductors of the grounded DC system due to an (unbalanced) insulation fault. After filtering the measuring voltage, a balancing current proportional to this measuring voltage is generated in the voltage-controlled power source and fed to the ground terminal of the class I operating equipment casing via the output circuit. Based on the detection of the DC fault current, the balancing current is thus set in such a manner in terms of a control that the DC protective-conductor current in the foundation ground electrode is minimized.

As an alternative to the aforementioned control, the balancing-current polarity and the balancing-current amplitude can be set by a regulation of a voltage-controlled power source.

In this context, the DC protective-conductor current is preferably registered on the protective conductor and fed back to the voltage-controlled power source by means of feedback so that the balancing current can be set in terms of polarity and amplitude in such a manner that the DC protective-conductor current is regulated (down) to a maximally permissible value. The DC protective-conductor current is thus regarded as a maximally permissible, presettable set value (reference variable) which is influenced by the DC fault current as a disturbance variable. Regulation appears to be a sensible alternative to control, especially when the DC fault current occurs as an uncontrollable disturbance which is difficult to measure.

As an alternative to using the voltage-controlled power source, the balancing-current polarity and the balancing-current amplitude is set by registering the amplitude and the polarity of a DC fault current, which is derived from the DC system in the protective conductor, upstream of the ground terminal by means of a current sensor; generating a measuring voltage proportional to the registered DC fault current by means of a current sensor; filtering the measuring voltage by means of a filtering device; and by switching balancing resistors by means of a resistance switching device in the output circuit between the fault-free active conductor and the ground terminal in order to generate the balancing current proportional to the measuring voltage.

In this embodiment, a symmetrical partial current is diverted from the fault-free active conductor as a balancing current. Its magnitude is determined by switched balancing resistors in the output circuit according to the registered DC fault current so that the minimum DC protective-conductor current is set downstream of the ground terminal.

The balancing resistors can be designed (physically) as ohmic or electronic resistors.

Preferably, the balancing resistors are switched via an approximation algorithm in an iteratively controlled manner.

The DC protective-conductor current can be minimized via an algorithm for successive approximation towards the minimum DC protective-conductor current.

As an alternative to the (iterative) control of the switching of the balancing resistors, the balancing-current polarity and the balancing-current amplitude is set by a regulation using a resistor switching device.

In this case, the DC protective-conductor current is registered on the protective conductor and fed back to the resistance switching device by means of feedback so that the compensating current can be set by switching the balancing resistors according to polarity and amplitude in such a manner that the DC protective-conductor current is regulated (down) with regard to a maximally permissible value.

As a further alternative to the use of the voltage-controlled power source or switching the balancing resistors, a balancing PWM signal is generated as a balancing current by means of a PWM generator.

The balancing current can be generated as a digitally modulated signal in the form of a PWM signal and be fed at the ground terminal. The frequency and duty cycle determine the balancing current required to minimize the DC protective-conductor current.

In addition to the aforementioned method of (DC) balancing using balancing current, the underlying task is attained using a method of (DC) compensation using a compensating current by feeding a compensating current to a casing of the class I operating equipment at a ground terminal via an output circuit between a faulty active conductor and the ground terminal, a compensating-current polarity and a compensating-current amplitude of the compensating current being set in such a manner that the DC protective-conductor current is minimized in the foundation ground electrode.

In the (DC) compensation method, a compensating current is fed at the ground terminal of the casing of the class I operating equipment via an output circuit extending between the faulty active conductor and the ground terminal.

The compensating current is set in such a manner in terms of polarity (compensating-current polarity) and amplitude (compensating-current amplitude) that the DC protective-conductor current is minimized in the foundation ground electrode. In contrast to DC balancing, in DC compensation the compensating current is not diverted from the active conductor of opposite polarity—relative to the phase of the faulty active conductor—but is routed in an output circuit from the faulty active conductor to the ground terminal at the protectively grounded casing of the class I operating equipment or an electrical enclosure.

In a further embodiment, the compensating-current polarity and the compensating-current amplitude is set by registering the amplitude and the polarity of a DC fault current, which is derived from the DC system in the protective conductor, upstream of the ground terminal by means of a current sensor; by generating a measuring voltage proportional to the registered DC fault current by means of the current sensor; by filtering the measuring voltage by means of a filtering device; by generating the compensating current proportional to the measuring voltage by means of a voltage-controlled power source.

The DC fault current, which is diverted to the protective conductor at the faulty conductor due to an insulation fault and is registered by a current sensor, generates a measuring voltage proportional to the detected DC fault current in the current sensor. After filtering the measuring voltage, the compensating current proportional to this measuring voltage is generated in the voltage-controlled power source and fed to the ground terminal of the casing of the class I operating equipment via the output circuit. Based on the registration of the DC fault current, the compensating current is set in such a manner that the DC protective-conductor current is minimized in the foundation ground electrode.

Analogous to the alternative procedure for DC balancing, the compensating-current polarity and the compensating-current amplitude of the compensating current can be set by a regulation.

In this context, the DC protective-conductor current is preferably detected on the protective conductor and fed back to the voltage-controlled power source by means of feedback so that the compensating current can be set in such a manner in terms of polarity and amplitude that the DC protective-conductor current is regulated (down) with regard to a maximally permissible value.

Furthermore, the compensating-current polarity and the compensating-current amplitude of the compensating current is set by setting a voltage-controlled negative resistance which is disposed in the output circuit.

The DC fault current can be compensated by a compensating current which is generated by means of a voltage-controlled negative resistance in the opposite direction to the DC fault current.

Similarly to the generation of the balancing current by a PWM generator, a compensating PWM signal can be generated as a compensating current by a PWM generator.

When several pieces of class I operating equipment are disposed in a grounded electrical enclosure, it is preferable to minimize the DC protective-conductor current in a shared grounding cable of the electrical enclosure.

If several pieces of class I operating equipment are disposed in the grounded electrical enclosure, effective protective grounding can be implemented for all pieces of class I operating equipment located in the grounded electrical enclosure via a shared grounding cable of the electrical enclosure designed as a protective conductor, the DC protective-conductor current being minimized in the common grounding cable.

In implementing the aforementioned methods according to the invention for minimizing a possibly corrosive DC protective-conductor current by feeding a balancing current or a compensating current, the invention comprises devices according to the invention based on a balancing device or a compensation device.

In the symmetry device, corresponding to the claimed balancing method, a voltage-controlled power source or a resistance switching device can be used to generate the balancing current with the balancing-current polarity and the balancing-current amplitude required, both required for minimizing the DC protective-conductor current.

In the compensation device, a voltage-controlled negative resistance can be used as an alternative to the voltage-controlled power source.

Both the balancing device and the compensation device can be designed as a control with registration of the DC fault current diverted to the protective conductor or as a regulation, preferably with registration and feedback of the minimum DC protective-conductor current.

In addition, a PWM generator can be used to generate the balancing current in the form of a balancing PWM signal or to generate the compensating current in the form of a compensating PWM signal.

In all cases, a current sensor is required for registering the respective current strength of the DC fault current or the DC protective-conductor current. The measuring voltage emitted by the current sensor is used as an input variable for the control or regulation of the balancing device, a compensation device, or a combination of both.

In the technical implementation of the methods according to the invention for minimizing a possibly corrosive DC protective-conductor current, the proportional measuring voltage generated by the current sensor is preferably first digitized using an analog/digital converter so that the subsequent processing steps can be carried out at the digital level in a microcontroller programmed with appropriate algorithms. These include, in particular, the digital filtering of the measuring voltage and the execution of the respective control and regulation of the balancing current and the compensating current as processor-based, digital implementations.

The invention presents supplementary corrosion protection measures, in particular for applications in which the measures proposed in the standard EN 50162 are difficult or impossible to implement and in which grounded DC systems should not involve higher costs than comparable alternating current (AC) and three-phase current (3AC) networks.

In particular, the claimed methods of balancing and compensation, together with the corresponding devices (balancing device and compensation device), can implement cost-effective measures for minimizing the DC protective-conductor current in a protective conductor designed as a foundation ground electrode at the ground terminal of the class I operating equipment or the electrical enclosure in the form of active corrosion protection to maximally permissible values. Electrolytic direct currents outside the closed grounding system are reduced and limited.

In this context, the methods according to the invention for compensating the DC fault current by means of the balancing current or the compensating current are carried out within the protectively grounded casing of the class I operating equipment or the electrical enclosure and not in the external protective-conductor system. Accordingly, the corresponding devices are also disposed within the class I operating equipment or electrical-enclosure casing in a manner that is easy to install and maintain, so that costly work on parts of the grounding system located outside the casing can be avoided.

The invention thus serves to prevent and minimize electro corrosion effects caused by DC stray currents by compensating an unbalanced insulation fault current in the grounded subsystem, such as the class I operating equipment, which is operated in a grounded network configuration, via suitable measures within this subsystem, i.e., within the casing of the class I operating equipment or the electrical-enclosure casing, exclusively by means of metallic current conduction. In addition, an automatic shutdown of the faulty DC system can be triggered in the event of an impermissibly high DC balancing current (or compensating current).

### BRIEF DESCRIPTION OF THE DRAWING FIGURES

Further advantageous embodiment features are derived from the following description and the drawings, which describe a preferred embodiment of the invention using examples.

FIG. 1 shows a simulation of a galvanically connected DC system having a protective conductor designed as a foundation ground electrode.

FIG. 2 shows a simulated balancing device according to the invention and having a voltage-controlled power source for the DC system.

FIG. 3 shows a simulated balancing device according to the invention and having a resistance switching device for the DC system.

FIG. 4 shows a simulated compensation device according to the invention and having a voltage-controlled power source for the DC system.

FIG. 5 shows a simulated compensation device according to the invention and having a voltage-controlled negative resistor for the DC system.

### DETAILED DESCRIPTION

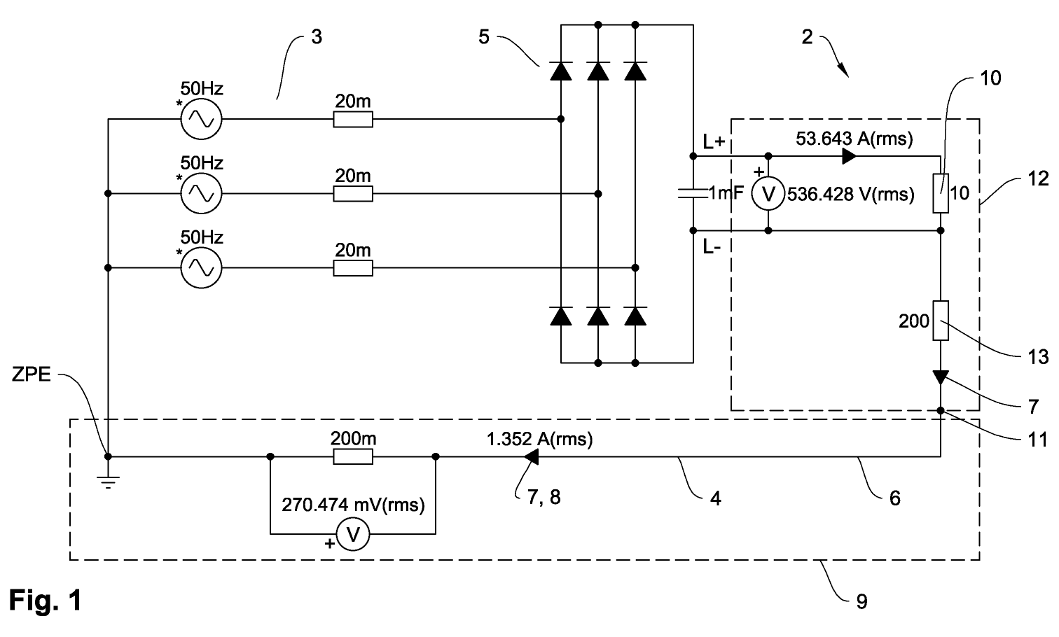

FIG. 1 shows a simulation arrangement of a galvanically connected DC system 2 having a protective conductor 6 designed as a foundation ground electrode 4 in a foundation 9, the simulation arrangement being provided with information on the current and voltage distribution.

The DC system 2 having active conductors L+, L- is galvanically connected to a 3AC network 3 via a three-phase rectifier 5.

Class I operating equipment 10, simulated as a 10 Ω resistive load and having a protectively grounded casing 12, is connected to the active conductors L+, L-. An insulation fault 13—exemplified here in the form of a (variable) 200 Ω resistor—is simulated between the active conductor L- and the protectively grounded casing 12 as a DC leakage current through which a DC fault current 7 flows. The DC fault current 7 continues via the ground terminal 11 of the casing 12 in the protective conductor 6, which is designed as a foundation ground electrode 4, as a DC protective-conductor current 8. In accordance with the normative requirements, the foundation ground electrode 4 has a resistance value of maximally 200 mΩ from the central grounding point ZPE to the ground terminal 11.

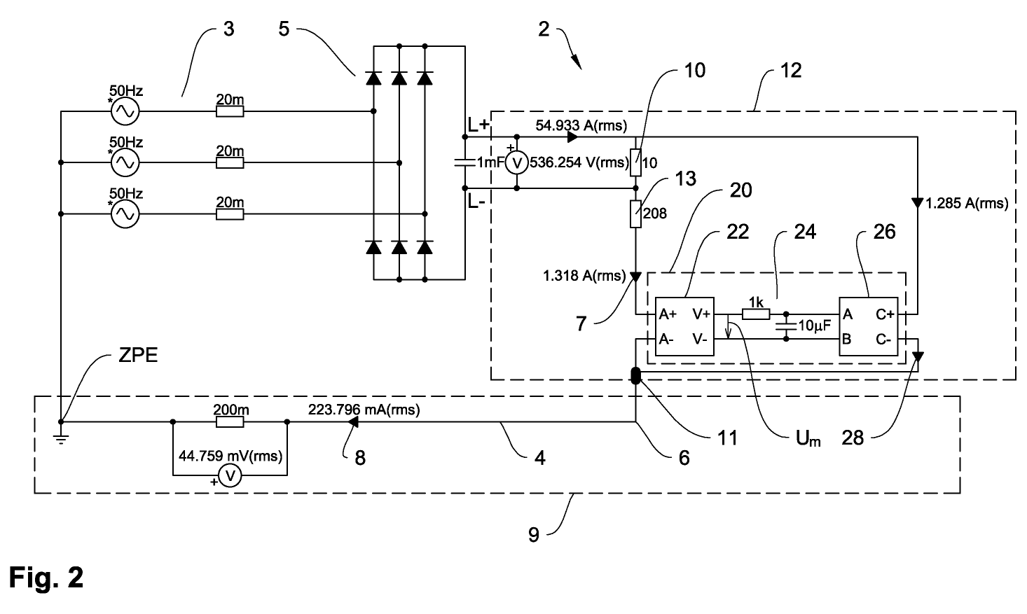

FIG. 2 shows a simulated balancing device 20 according to the invention and having a voltage-controlled power source 26 for the DC system 2.

The following simulation arrangements reflect the solutions according to the invention at a functional level. In the device-related implementation, the claimed processing steps are preferably implemented as digital signal processing algorithms on a microcontroller after an analog/digital conversion on the input side.

The simulation arrangement shows the class I operating equipment 10 operated to ground in the DC system 2 and an insulation fault 13 simulated here as a 208 Ω resistor and disposed between the active conductor L- and the ground terminal 11 located on the protectively grounded casing 12 of the class I operating equipment 10.

The balancing device 20 comprises a current sensor 22, which registers the amplitude and polarity of the DC fault current 7 diverted from the faulty active conductor L- to the protective conductor 6 and generates a measuring voltage Uₘ proportional to the registered DC fault current 7 of one volt at the output V+, V- of the current sensor 22 for each ampere of the input-side DC fault current 7 (input A+, A- of the current sensor 22).

In the device according to the invention to be implemented, the current sensor 22 is preferably designed as a DC measuring current transformer (DC differential current sensor).

A downstream filtering device 24 consists of a simple RC low-pass filter for suppressing mains-frequency AC components.

The voltage-controlled power source 26 generates a balancing current 28 flowing via the outputs C+, C- of the power source 26 in an output circuit, which extends between the fault-free active conductor L+ (of opposite phase to L-) and the ground terminal 11 on the protectively grounded casing 12, per volt input voltage supplied at the inputs A, B of the power source 26.

The balancing device 20 causes the DC current diversion to be symmetrically balanced at the ground terminal 11 against the protectively grounded casing 12, thereby reducing the DC current component of the DC protective-conductor current 8 in the protective conductor 6 in order to prevent electro corrosion effects in the foundation ground electrode 4.

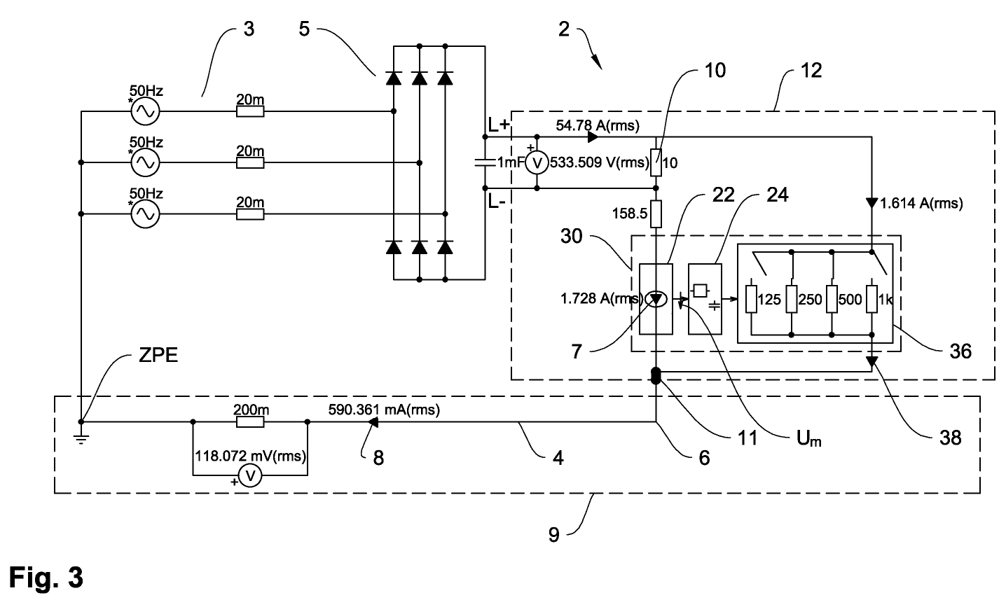

FIG. 3 shows a simulated balancing device 30 according to the invention and having a resistance switching device 36 for the DC system 2.

The balancing device 30 according to the invention also comprises a current sensor 22, which registers the amplitude and polarity of the DC fault current 7 diverted from the faulty active conductor L- to the protective conductor 6 and generates a corresponding measuring voltage Uₘ, and further comprises a filtering device 24 for suppressing the mains-frequency AC components.

In this embodiment, as an alternative to the voltage-controlled power source 26 (FIG. 2), the balancing current 38 proportional to the filtered measuring voltage Uₘ is caused by switching balancing resistors by means of a resistance switching device 36 in the output circuit between the fault-free active conductor L+ and the ground terminal 11.

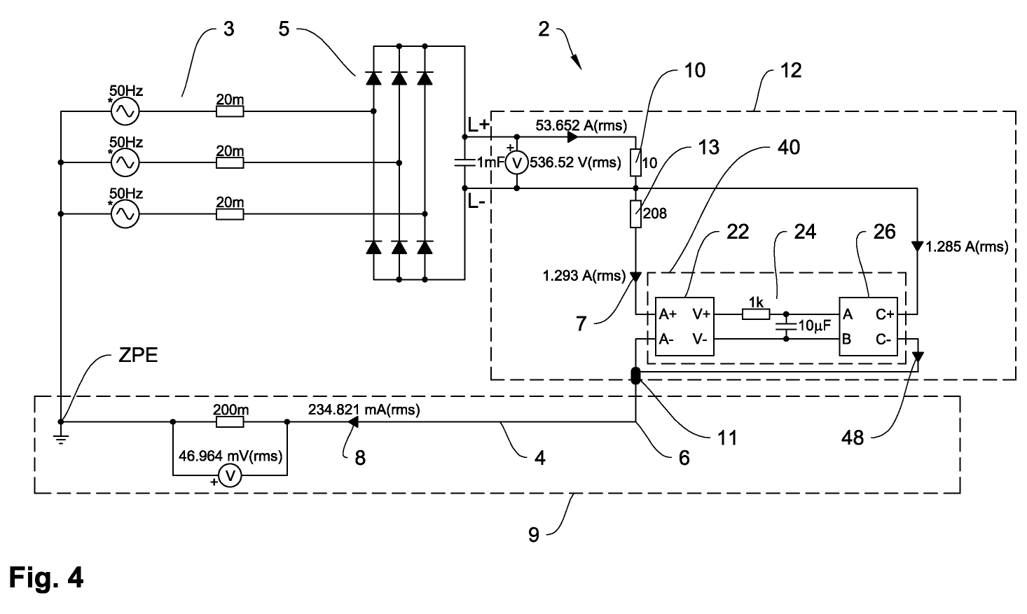

FIG. 4 shows a simulated compensation device 40 according to the invention and having a voltage-controlled power source 26 for the DC system 2.

The structure of the compensation device 40 largely corresponds to that of the balancing device 20 having a voltage-controlled power source 26 (FIG. 2), but in this case for generating the compensating current 48 having a suitable compensating-current polarity and a compensating-current amplitude. In contrast to balancing, compensation means the compensating current 48 is not diverted from the fault-free active conductor L+ having opposite-phase polarity (relative to the faulty active conductor L-), but rather the output circuit carrying this compensating current 48 extends via the faulty conductor L- to the ground terminal 11.

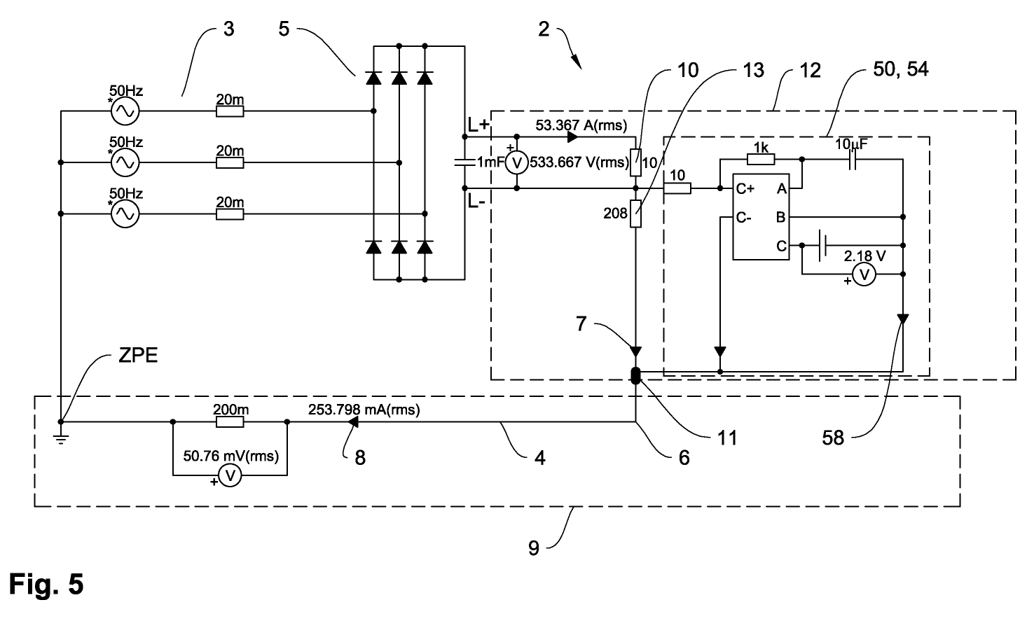

FIG. 5 shows a simulated compensation device 50 according to the invention and having a voltage-controlled negative resistance 54 for the DC system 2.

In this embodiment, the compensating current 58 is generated by a voltage-controlled negative resistance 54, the controllable or settable negative resistance 54 being able to be implemented in various manners as an active component group having a negative current-voltage characteristic curve in analog or digital electronics, for example in the form of a negative-impedance converter.

If the DC balancing current or the compensating current generated according to the invention exceeds an amplitude considered to be critical (balancing-current or compensating-current amplitude), the faulty, grounded DC system 2 can preferably be automatically shut down.

1. A method for minimizing a possibly corroding DC protective-conductor current (8) for a DC system (2), which is grounded via a protective conductor (6) designed as a foundation ground electrode (4) and has connected SK 1-operating equipment (10), the method comprising the following steps:
feeding a balancing current (28) to a casing (12) of the class I operating equipment (10) at a ground terminal (11) via an output circuit between a fault-free active conductor (L+) and the ground terminal (11),
a balancing-current polarity and a balancing-current amplitude of the balancing current (28, 38) being set in such a manner that the DC protective-conductor current (8) is minimized in the foundation ground electrode (4).

2. The method according to claim 1,
wherein
the balancing-current polarity and the balancing-current amplitude is set by
registering the amplitude and the polarity of a DC fault current (7), which is derived from the DC system (2) in the protective conductor (6), upstream of the ground terminal (11) by means of a current sensor (22);
generating a measuring voltage (Uₘ) proportional to the registered DC fault current (7) by means of the current sensor (22);
filtering the measuring voltage (Uₘ) by means of a filtering device (24); and
generating the balancing current (28) proportional to the measuring voltage (Uₘ) by means of a voltage-controlled power source (26).

3. The method according to claim 1,
wherein
the balancing-current polarity and the balancing-current amplitude is set by a regulation of a voltage-controlled power source (26).

4. The method according to claim 1,
wherein
the balancing-current polarity and the balancing-current amplitude is set by
registering the amplitude and the polarity of a DC fault current (7), which is derived from the DC system (2) in the protective conductor (6), upstream of the ground terminal (11) by means of a current sensor (22);
generating a measuring voltage (Uₘ) proportional to the registered DC fault current (7) by means of a current sensor (22);
filtering the measuring voltage (Uₘ) by means of a filtering device (24); and by
switching balancing resistors by means of a resistance switching device (36) in the output circuit between the fault-free active conductor (L+) and the ground terminal (11) in order to generate the balancing current (38) proportional to the measuring voltage (Uₘ).

5. The method according to claim 4,
wherein
the balancing resistors are switched via an approximation algorithm in an iteratively controlled manner.

6. The method according to claim 1,
wherein
the balancing-current polarity and the balancing-current amplitude is set by a regulation using a resistor switching device (36).

7. A method for minimizing a possibly corroding DC protective-conductor current (8) for a DC system (2), which is grounded via a protective conductor (6) designed as a foundation ground electrode (4) and has connected class I operating equipment (10), the method comprising the following steps:
feeding a compensating current (48, 58) to a casing (12) of the class I operating equipment (10) at a ground terminal (11) via an output circuit between a faulty active conductor (L-) and the ground terminal (11),
a compensating-current polarity and a compensating-current amplitude of the compensating current (48, 58) being set in such a manner that the DC protective-conductor current (8) is minimized in the foundation ground electrode (4).

8. The method according to claim 7,
wherein
the compensating-current polarity and the compensating-current amplitude is set by
registering the amplitude and the polarity of a DC fault current, which is derived from the DC system (2) in the protective conductor (6), upstream of the ground terminal (11) by means of a current sensor (22);
generating a measuring voltage (Uₘ) proportional to the registered DC fault current (7) by means of the current sensor (22);
filtering the measuring voltage (Uₘ) by means of a filtering device;
generating the compensating current (48) proportional to the measuring voltage (Uₘ) by means of a voltage-controlled power source.

9. The method according to claim 7,
wherein
the compensating-current polarity and the compensating-current amplitude of the compensating current (58) is set by setting a voltage-controlled negative resistance (54) which is disposed in the output circuit.

10. The method according to claim 1,
wherein
the DC protective-conductor current (8) is minimized in a shared grounding cable of a grounded electrical enclosure when several pieces of class I operating equipment (10) is disposed in the shared electrical enclosure.

11. A device for minimizing a possibly corroding DC protective-conductor current (8) for a DC system (2), which is grounded via a protective conductor (6) designed as a foundation ground electrode (4) and has connected class I operating equipment (10),
wherein
a balancing device (20, 30) which feeds a balancing current (28, 38) to a casing (12) of the class I operating equipment (10) at a ground terminal (11) via an output circuit between a fault-free active conductor (L+) and the ground terminal (11) and is configured for setting a balancing-current polarity and a balancing-current amplitude of the balancing current (28, 38) in such a manner that the DC protective-conductor current (8) is minimized in the foundation ground electrode (4).

12. The device according to claim 11,
wherein
a current sensor (22) for registering the amplitude and the polarity of a DC fault current (7), which is derived from the DC system (2) in the protective conductor (6), upstream of the ground terminal (11) and for generating a measuring voltage (Uₘ) proportional to the registered DC fault current (7); a filtering device (24) for filtering the measuring voltage (Uₘ); and a voltage-controlled power source (26) for generating the balancing current (28) proportional the measuring voltage (Uₘ).

13. The device according to claim 11,
wherein
a regulation using a voltage-controlled power source (26) for setting the balancing-current polarity and the balancing-current amplitude.

14. The device according to claim 11,
wherein
a current sensor (22) for registering the amplitude and the polarity of a DC fault current (7), which is derived from the DC system (2) in the protective conductor (6), upstream of the ground terminal (11) and for generating a measuring voltage (Uₘ) proportional to the registered DC fault current (7); a filtering device (24) for filtering the measuring voltage (Uₘ); and a resistance switching device (36) for switching balancing resistors in the output circuit between the fault-free active conductor (L+) and the ground terminal (11) in order to generate the balancing current (38) proportional to the measuring voltage (Uₘ).

15. The device according to claim 14,
wherein
the resistance switching device (36) is configured for iteratively controlling the switching of the balancing resistors via an approximation algorithm.

16. The device according to claim 11,
wherein
a regulation using a resistance switching device (36) for setting the balancing-current polarity and the balancing-current amplitude.

17. A device for minimizing a possibly corroding DC protective-conductor current (8) for a DC system (2), which is grounded via a protective conductor (6) designed as a foundation ground electrode (4) and has connected class I operating equipment (10),
wherein
a compensation device (40, 50) which feeds a compensating current (48, 58) to a casing (12) of the class I operating equipment (10) at a ground terminal (11) via an output circuit between a faulty active conductor (L-) and the ground terminal (11) and is configured for setting a compensating-current polarity and a compensating-current amplitude of the compensating current (48, 58) in such a manner that the DC protective-conductor current (8) is minimized in the foundation ground electrode (4).

18. The device according to claim 17,
wherein
a current sensor (22) for registering the amplitude and the polarity of a DC fault current (7), which is derived from the DC system (2) in the protective conductor (6), upstream of the ground terminal (11) and for generating a measuring voltage (Uₘ) proportional to the registered DC fault current (7); a filtering device (24) for filtering the measuring voltage (Uₘ); and a voltage-controlled power source (26) for generating the compensating current (48) proportional to the measuring voltage.

19. The device according to claim 17,
wherein
a regulation using a voltage-controlled power source (26) for setting the compensating-current polarity and the compensating-current amplitude of the compensating current (48).

20. The device according to claim 17,
wherein
a voltage controlled negative resistor (54) which is disposed in the output circuit and is configured to set the compensating-current polarity and the compensating-current amplitude of the compensating current (58).
